(19) United States
(12) Patent Application Publication
(10) Pub. No.: US 2014/0369230 A1
(43) Pub. Date: Dec. 18, 2014

(54) Virtual Chassis Topology Management

(71) Applicant: Pramoda V. Nallur, Midvale, UT (US)

(72) Inventor: Pramoda V. Nallur, Midvale, UT (US)

(73) Assignee: ALCATEL-LUCENT USA INC., Murray Hill, NJ (US)

(21) Appl. No.: 13/920,604

(22) Filed: Jun. 18, 2013

(51) Int. Cl. H04L 12/751

(52) U.S. Cl. CPC H04L 45/02
USPC 370/254

(57) ABSTRACT

Topology management within a virtual chassis is achieved by communicating virtual chassis topology information between switches within the virtual chassis within protocol extensions of customized protocol data units (PDUs) associated with a VC-ISIS protocol. The virtual chassis topology information can be used, for example, to detect the topology of the virtual chassis and generate a shortest path tree within each switch of the virtual chassis for use in routing between switches within the virtual chassis.

### CROSS-REFERENCE TO RELATED PATENTS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not applicable.

### BACKGROUND

1. Technical Field

This invention relates generally to data networks and in particular to virtual chassis architectures.

2. Description of Related Art

Data networks allow many different computing devices, for example, personal computers, IP telephony devices or servers to communicate with each other and/or with various other network elements or remote servers attached to the network. For example, data networks may comprise, without limitation, Metro Ethernet or Enterprise Ethernet networks that support multiple applications including, for example, voice-over-IP (VoIP), data and video applications. Such networks regularly include many interconnected nodes, commonly known as switches or routers, for routing traffic through the network.

The various nodes are often distinguished based on their location within particular areas of the network, commonly characterizing two or three “tiers” or “layers,” depending on the size of the network. Conventionally, a three tier network consists of an edge layer, an aggregation layer and a core layer (whereas a two tier network consists of only an edge layer and core layer). The edge layer of data networks includes edge (also called access) networks that typically provide connectivity from an Enterprise network or home network, such as a local area network, to a metro or core network. The edge/access layer is the entry point of the network, i.e., to which the customer network is nominally attached, and the switches residing at the edge layer are known as edge nodes. Different types of edge networks include digital subscriber line, hybrid fiber coax (HFC), fiber to the home and enterprise networks, such as campus and data center networks. Edge nodes may perform, for example, L2 switching functions for the attached devices. The edge nodes are generally connected to one or more Enterprise switches and/or end devices in the customer network, and also to an aggregate layer that terminates access links coming from multiple edge nodes. Switches residing at the aggregation layer are known as Aggregation Switches. Aggregation Switches may perform, for example, L2 switching and L3 routing of traffic received via the aggregate links from the edge nodes. The aggregate layer is connected to a metro or core network layer that performs Layer 3/IP routing of traffic received from the Aggregation Switches (in a three tier network) or from edge nodes (in a two tier network). As will be appreciated, nodes at each incremental layer of the network typically have larger capacity and faster throughput.

One of the key challenges faced by data networks is the need for network resiliency, i.e., the ability to maintain high availability despite eventual component failures, link failures or the like, which is critical to providing satisfactory network performance. Network resiliency may be achieved in part through topological redundancy, i.e., by providing redundant nodes (and redundant components within nodes) and multiple physical paths between nodes to prevent single points of failure, and in part through L2/L3 protocols to exploit the redundancy upon occurrences of failures to converge upon alternate paths for switching/routing traffic flows through the network.

In one known solution, a virtual chassis may be used to provide redundancy, while also providing increased throughput and bandwidth. Within a virtual chassis, two or more physical Ethernet switches can be coupled together to form a single logical form factor operating as a single switch/router with a unified control plane and configuration file. Route and switch engine redundancy are typically managed by a virtual chassis master switch through the creation and maintenance of synchronized forwarding tables and the exchange of control information between counterpart/peer applications running on the switches. Thus, neighbor discovery, optimal forwarding paths, failure detection and recovery must all be supported within a virtual chassis.

### BRIEF DESCRIPTION OF THE SEVERAL VIEWS OF THE DRAWINGS

FIG. 1 illustrates a schematic block diagram of an embodiment of a virtual chassis;

FIG. 2 illustrates a schematic block diagram of another embodiment of a virtual chassis;

FIG. 3 illustrates a schematic block diagram of an embodiment of a switch within a virtual chassis;

FIGS. 4 and 5 illustrate an embodiment of an exemplary format a customized Hello Protocol Data Unit (PDU);

FIGS. 6 and 7 illustrate an embodiment of an exemplary format of a customized Link State PDU; and

FIG. 8 illustrates an exemplary flow diagram of an embodiment of a method for topology management within a virtual chassis.

### DETAILED DESCRIPTION

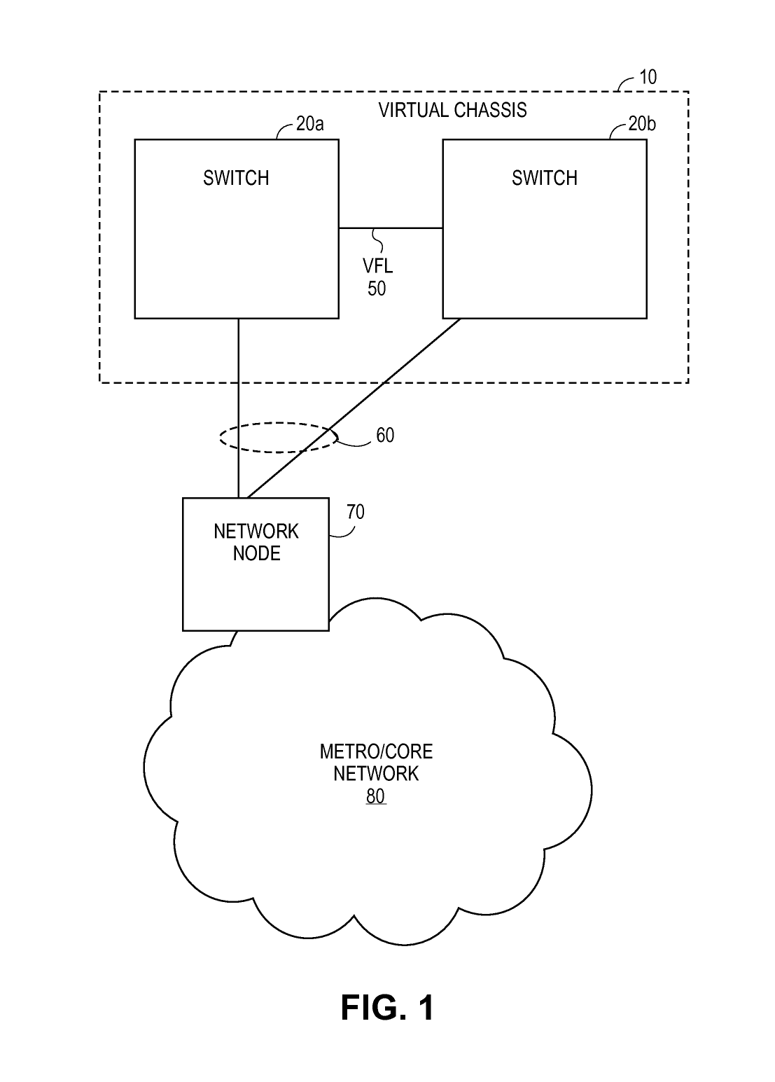

FIG. 1 illustrates an embodiment of a virtual chassis 10 in accordance with the present invention. The virtual chassis 10 includes two or more Ethernet switches 20a and 20b that collectively form a single logical switch. The virtual chassis 10 has a Media Access Control (MAC) address and Internet Protocol (IP) address used by external nodes to forward traffic to the virtual chassis 10. Each switch 20a and 20b within the virtual chassis 10 is further assigned a unique identifier (i.e., IP address or other internal identifier for communication between the software components residents on the switches) used for routing between the switches 20a and 20b.

The Ethernet switches 20a and 20b are coupled together via a virtual fabric link (VFL) 50. The VFL 50 provides a connection for exchange of information between the switches 20a and 20b regarding traffic forwarding, MAC addressing, multicast flows, address resolution protocol (ARP) tables, Layer 2 control protocols (e.g. spanning tree, Ethernet ring protection, logical link detection protocol), routing protocols (e.g. RIP, OSPF, BGP) and the status of links connecting the virtual chassis 10 to other upstream/downstream nodes. MAC address/forwarding tables for external nodes are maintained in each switch 20a and 20b to enable bridging or routing packets between switches 20a and 20b to reach external destination devices. For example, when a packet is to be routed from one switch (e.g., switch 20a) to another switch (e.g., switch 20b) within the virtual chassis 10 for transmission to an external destination device, a pre-pended header is added to the packet that includes the identifier of source switch 20a and the identifier of the destination switch 20b.

The switches 20a and 20b are separate physical switches, each operable as a stand-alone switch. The switches 20a and 20b may be encased together in a single physical chassis or in two or more separate physical chasses. Depending on the chassis configuration, the switches 20a and 20b may be in the same geographic area, such as in a central office or data center, or may be separate geographic locations, such as different buildings or cities, to provide geo diversity.

In addition, the switches 20a and 20b within the virtual chassis 10 may be Aggregate switches, Edge switches or Enterprise switches. In embodiments in which the switches 20a and 20b are Enterprise switches, the virtual chassis 10 is connected downstream to one or more end devices within a Local Area Network (LAN) and upstream to one or more Edge switches. In embodiments in which the switches 20a and 20b are Edge switches, the virtual chassis 10 is connected downstream to one or more Enterprise switches and/or end devices within a LAN or home network and upstream to one or more Aggregate switches or network nodes, such as network switches and/or routers within a metro/core network 80. In embodiments in which the switches 20a and 20b are Aggregate switches, the virtual chassis 10 is connected downstream to one or more Edge switches and upstream to one or more network nodes within the metro/core network 80. In FIG. 1, the virtual chassis 10 represents an Edge or Aggregate switch that is coupled to one or more network nodes 70 within the metro/core network 80.

In an embodiment, the connection between the virtual chassis 10 and the network node 70 is formed by a multi-chassis link aggregation group (MC-LAG) 60, in which two or more physical links connect the network node 70 with two or more of the switches 20a and 20b within the virtual chassis 10, as described in U.S. patent application Ser. No. 13/010,169, entitled “System and Method for Multi-Chassis Link Aggregation,” filed on Jan. 20, 2011, which is incorporated herein by reference. For example, as shown in FIG. 1, a respective external physical link connects each of the switches 20a and 20b to the network node 70 within the metro/core network 80 to form a MC-LAG 60. In an exemplary embodiment, the virtual chassis 10 and/or network node 70 may use load balancing techniques to distribute traffic across all of the available links of the MC-LAG 60. For example, for each packet transmitted over the MC-LAG 60, one of the physical links is selected based on a load-balancing algorithm (typically involving a hash function operating on the source and destination Internet Protocol (IP) or Media Access Control (MAC) address information).

In another embodiment, the switches 20a and 20b may be connected to upstream and/or downstream nodes using standard Link Aggregation Groups (LAGs) or other trunks or links. It should be understood that as used herein, the term “LAG” refers to the bundling of several physical links between two nodes to form a single logical channel therebetween using the Link Aggregation Control Protocol (LACP), as defined in IEEE 802.1AX-IEEE 802.3ad released on Nov. 3, 2008.

Regardless of the type of connection between the virtual chassis 10 and the upstream and/or downstream nodes, the switches 20a and 20b operate transparently to the upstream and downstream nodes and are treated as a single logical device (virtual chassis 10) by the upstream and downstream nodes. Therefore, the upstream and downstream nodes are able to actively forward traffic to the virtual chassis 10, while the synchronization of MAC address tables and other forwarding information between the switches 20a and 20b is driven by L2 packet flows and control messaging over the VFL 50.

In one embodiment, the switches 20a and 20b are operating in an active/passive environment, in which not all of the external links are actively forwarding traffic at the same time (i.e., the external links on one switch are active, while the external links on other switches remain passive or “on standby”). In this embodiment, Spanning Tree Protocol (STP) may be used to bring an alternate path out of the standby mode and into an active state to re-establish a connection upon failure of an active link. In another embodiment, the switches 20a and 20b are operating in an active/active environment, in which all external links are simultaneously active (i.e., the external links on all switches are active). In this embodiment, STP may not need to be run in some or all portions of the network topology for loop prevention (e.g., STP may still be utilized over the VFL 50 as well as over the links connecting the virtual chassis 10 to upstream/core switches within the network 80).

In accordance with various embodiments, the switches 20a and 20b within the virtual chassis 10 utilize a unique Virtual Chassis Intermediate System-to-Intermediate System protocol (VC-ISIS) for communication over the VFL 50. The VC-ISIS protocol enables the switches 20a and 20b to exchange system-specific information (hereinafter referred to as topology information) for topology management within the virtual chassis 10. The topology information can be used, for example, for neighbor detection, topology advertisement, optimal forwarding path determination (shortest path bridging), failure detection and failure recovery within the virtual chassis 10. By way of example, but not limitation, the topology information can include information specific to virtual chassis applications, switch hardware and system software performance parameters.

The VC-ISIS protocol defines various customized protocol extensions that can be added to the existing ISIS protocol, as defined in ISO/IEC 10589:2002, and is termed VC-ISIS to differentiate the protocol from existing ISIS implementations (e.g., ISIS for IP and ISIS-SPB). The customized protocol extensions of the VC-ISIS protocol carry the topology information, and can be implemented, for example, in the form of Type/Length/Value (TLV) fields to define customized protocol data units (PDUs), such as customized Hello PDUs and/or customized Link State PDUs, of the VC-ISIS protocol. The customized PDUs assist in the automatic detection and configuration of the switches 20a and 20b within the virtual chassis 10 and in the generation of shortest path bridging trees rooted at each switch 20a and 20b within the virtual chassis 10. In addition, the periodic exchange of the customized PDUs between the switches 20a and 20b can result in fast and optimal convergence times for the recalculation of shortest path trees during failure recovery. For example, in one embodiment, customized Hello PDUs are exchanged at sub-second time intervals between the switches 20a and 20b to negotiate rapid failure detection. The exchanged topology information may also be used to facilitate the election of a master switch within the virtual chassis.

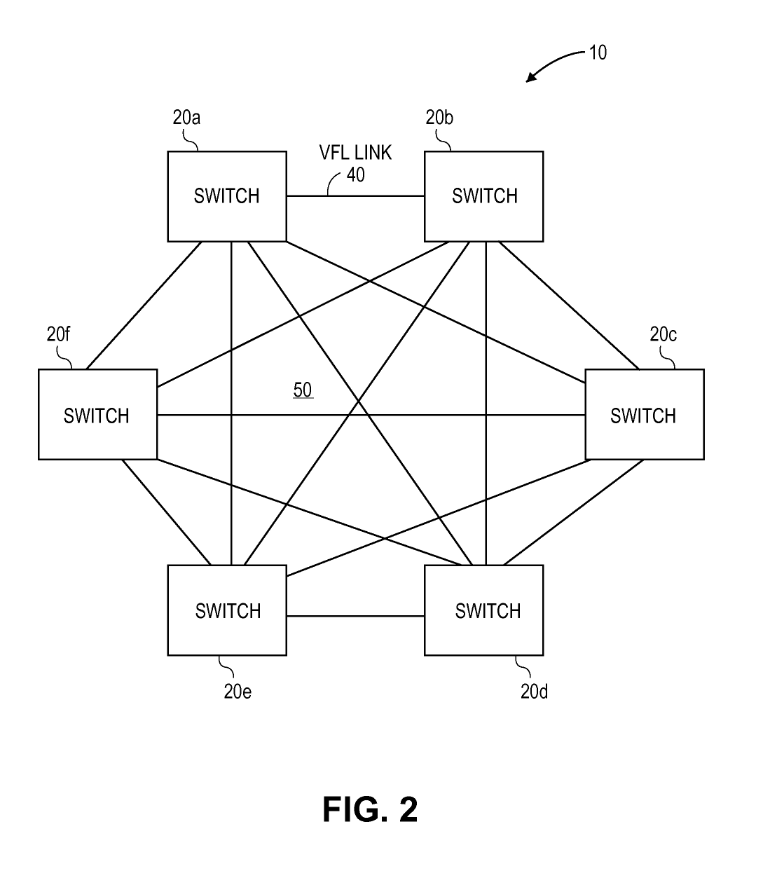

The VC-ISIS protocol is also scalable to deliver robust and acceptable performance in terms of forwarding path convergence regardless of the number of switches 20a and 20b within the virtual chassis 10. For example, as shown in FIG. 2, six switches 20a-20f are coupled together in a mesh topology using VFL links 40 that collectively form the VFL 50. As can be appreciated, as the number of switches 20a and 20b within the virtual chassis 10 increases, topology detection and shortest path bridging becomes increasingly critical. The VC-ISIS protocol (with protocol extensions) enables and optimizes the topology management in any type of virtual chassis topology. Thus, the VC-ISIS protocol provides efficient and reliable control plane functionality for virtual chassis topology management without the need for external intervention or visibility on the part of the user/administrator.

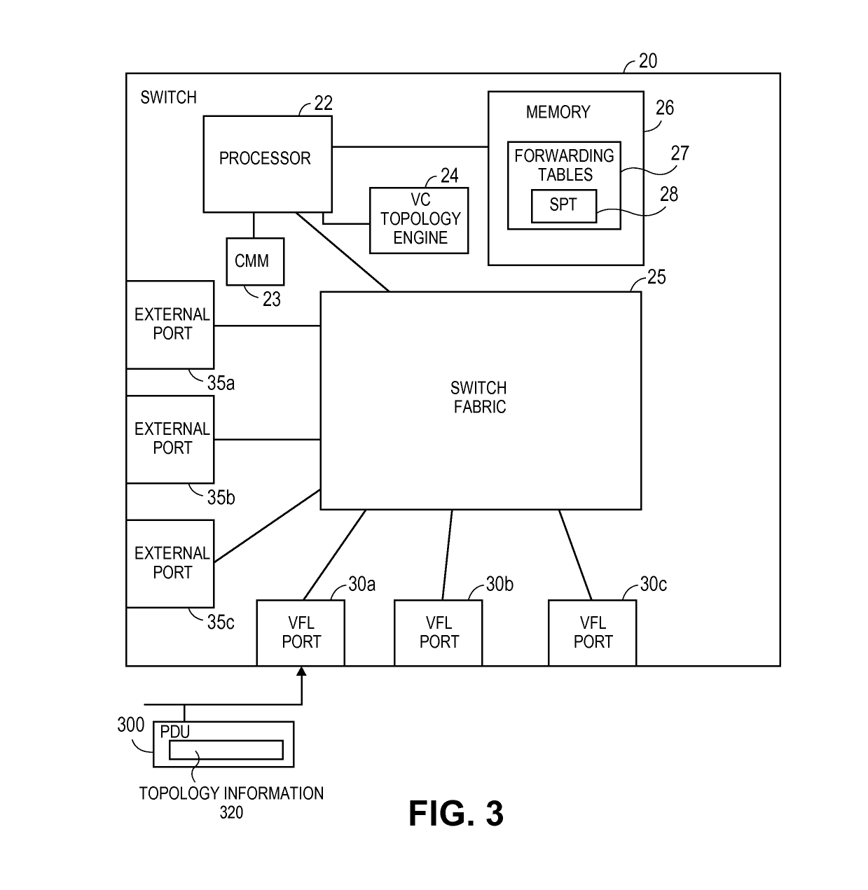

FIG. 3 illustrates an exemplary embodiment of a switch 20 within a virtual chassis. The switch 20 includes one or more Virtual Fabric Link (VFL) ports 30a-30c and one or more external ports 35a-35c. The VFL ports 30a-30c provide connections to links that form the VFL. The external ports 35a-35c provide connections to links to external upstream and/or downstream nodes. One or more of the external ports 35a-35c may include member ports for a MC-LAG physical link, LAG or other trunk group, fixed link, etc. The VFL ports 30a-30c and external ports 35a-35c may have the same physical interface type, such as copper ports (CAT-5E/CAT-6), multi-mode fiber ports (SX) or single-mode fiber ports (LX). In another embodiment, the VFL ports 30a-30c and external ports 35a-35c may have one or more different physical interface types.

The switch 20 further includes a processor 22, Chassis Management Module (CMM) 23 (which may include both a primary CMM and back-up CMM), virtual chassis (VC) topology engine 24, switch fabric 25 and non-transitory memory device 26. The VC topology engine 24 includes an algorithm (or set of instructions) interpretable and executable by the processor 38 to cause the processor 38 to carry out operations for virtual chassis topology management within the switch 20, such as neighbor discovery, topology advertisement, shortest path bridging, failure detection and recovery. In addition, the CMM 23 also includes an algorithm (or set of instructions) interpretable and executable by the processor 38 to cause the processor 38 to carry out operations for managing the switch (chassis). The VC topology engine 24 and CMM 23 may be stored, for example, in the non-transitory memory device 26 or another non-transitory memory device within switch 20.

As used herein, the term “processor” is generally understood to be a device that drives a general-purpose computer. By way of example, but not limitation, the “processor” 38 may include one or more of a microprocessor, microcontroller, central processing unit (CPU), Field Programmable Gate Array (FPGA), Application Specific Integrated Circuit (ASIC), or any other processing device. In addition, as used herein, the term “non-transitory memory device” is generally understood to include a device that is used to store data and/or programs for use in a general-purpose computer. By way of example, but not limitation, the “non-transitory memory device” 39 may include one or more of a data storage device, random access memory (RAM), read only memory (ROM), flash memory, compact disc, ZIP™ drive, tape drive, database or other type of storage device or storage medium.

The VC topology engine 24, in combination with the CMM 23, automates the detection of other switches within the virtual chassis and the generation of a shortest path tree (SPT) 28 for routing between the switch 20 and other switches within the virtual chassis. The CMM 23 creates a logical inter-process communication (IPC) with CMMs on other switches within the virtual chassis (VC switches) to exchange VC-ISIS Protocol Data Units 300 with the other VC switches. The VC topology engine 24 generates VC-ISIS PDUs 300 for transmission to other VC switches and processes VC-ISIS PDUs 300 received from other VC switches via one or more of the VFL ports 30a-30c. It should be noted that the VC topology engine 24 may run as part of the CMM 23 or run separate from (or alongside) the CMM 23.

The VC topology engine 24 extracts topology information 320 from received VC-ISIS PDUs 300 and builds a topological representation (map) of the virtual chassis by aggregating the topology information 320 received from each VC switch. This map indicates, for example, the VC switches that each VFL port 30a-30c can reach. Based on this map and other topology information 320 (e.g., link state information), the VC topology engine 24 creates the SPT 28, which indicates the lowest-cost (shortest) path to a particular switch within the virtual chassis for forwarding traffic. For example, the VC topology engine 24 can compute next-hop information and sets of equal-cost paths, thus creating an adjacency set that may be used, for example, for load balancing.

The CMM 23 utilizes the SPT 28, along with received VC-ISIS PDUs 300 and other PDUs (i.e., PDUs generated external to the virtual chassis), to update a MAC/HDI Forwarding Table 27 maintained in the memory device 26. The MAC/HDI Forwarding Table 27 includes a list of MAC address entries, such as MAC addresses for other VC switches, software within the switch 20 and other VC switches, hardware within the switch 20 and other VC switches and external (upstream or downstream) devices. The MAC address entries include associated hardware device information (HDI) used in bridging or routing a packet to reach a device with the associated MAC address. The destination hardware device information includes, for example, the port identifier of either the switch 20 or another VC switch associated with the destination MAC address. The MAC/HDI forwarding table 27 may include one or more tables, such as a source trunk map, trunk bitmap table, trunk group table, VLAN mapping table, etc. In addition, the VC topology engine 24 may program the SPT 28 into the MAC/HDI Forwarding Table 27.

In an exemplary operation, the VC topology engine 24 is executable by the processor 22 to communicate with other switches in the virtual chassis via one or more of the VFL ports 30a-30c to run a topology discovery process that discovers each switch within the virtual chassis and various attributes of each switch (e.g., identifier of each switch, MAC addresses of switches, switch priority, VLANs associated with each switch, etc.) to generate the SPT 28. For example, the VC topology engine 24 can process VC-ISIS protocol data units (PDUs) 300 received on one or more VFL ports 30a-30c from one or more other switches within the virtual chassis by extracting the topology information 320 from the PDUs 300 and generating the SPT 28 from the topology information 320. The CMM 23 is further executable by the processor 22 to create or update the MAC/HDI Forwarding Table 27 based on the SPT 28 and various received PDUs (e.g., VC-ISIS PDUs 300 and/or external PDUs). For example, the VC topology engine 24 can provide topology information 320 extracted from received VC-ISIS PDUs 300 to the CMM 23 for use in updating the MAC/HDI Forwarding Table 27. The processor 22 can then use the SPT 28 and/or MAC/HDI Forwarding Table 27 to switch incoming traffic (arriving on a VFL port 30a-30c or an external port 35a-35c) via switch fabric 25 to other ports 30a-30c or 35a-35c on the switch 20.

In another embodiment, the VC topology engine 24, in combination with the CMM 23, further automates the configuration of the switch 20 upon initialization of the switch 20 and/or other switches within the virtual chassis and/or during recovery after failure of the switch 20 and/or other switches in the virtual chassis. For example, the VC topology engine 24 can send and/or receive license information related to one or more software licenses for software installed on the switch 20 and/or other VC switches for use by the CMM 23 or other software module in ensuring that the virtual chassis has the appropriate software licenses for all of the software installed on the VC switches.

As another example, the VC topology engine 24 may send and/or receive certain topology information for use by the CMM 23 or other software module in electing a master switch within the virtual chassis. The master switch is the central point of management (configuration and monitoring) for the virtual chassis and all applications running on the switches within the virtual chassis. For example, the master switch may be responsible for controlling load sharing, switching/routing and communication between the switches and for managing redundancy within the virtual chassis.

In an exemplary operation, the VC topology engine 24 is executable by the processor 22 to support a master election process that elects a master switch based on the switch attributes of each switch and/or other election criteria. For example, in an exemplary operation, upon initialization of the virtual chassis, a master election process is initiated within the virtual chassis to elect a master switch from all of the switches within the virtual chassis. The master election process may utilize, for example, a virtual chassis master election algorithm (running as part of the CMM 23 or separate from the CMM 23) that considers various election criteria, such as which switch has the lowest identifier/MAC address, which switch has the highest priority, which switch has the longest uptime, and/or other criteria, to elect the master switch. The election criteria can be provided, for example, by the VC topology engine 24 using topology information 320 extracted from received PDUs 300.

In one embodiment, the received VC-ISIS PDUs 300 are customized Hello PDU's. In addition, the switch 20 can also generate customized Hello PDUs and transmit the Hello PDUs out all of the VFL ports 30a-30c. As discussed above, the switch 20 can process the received customized Hello PDUs 320 to discover neighbors and establish adjacencies. For example, switches within the virtual chassis sharing a common VFL link will become VC-ISIS neighbors if their customized Hello PDUs contain information that meets the criteria for forming an adjacency. Based on the adjacency information, the switch can create a topological map and then generate the shortest path tree (SPT) 28.

As further discussed above, the customized Hello PDU's 300 include topology information 320 that is specific to the virtual chassis. For example, the customized Hello PDUs 300 can include a switch identifier that is unique to the virtual chassis, along with the MAC address of the switch. In addition, in an exemplary embodiment, the customized Hello PDU 300 can further include a sub-second Hello time interval value that enables the customized Hello PDUs 300 to be exchanged (generated and transmitted to each switch) at sub-second (less than one second) time intervals. By exchanging the customized Hello PDUs 300 more frequently, the VC topology engine 24 is able to more rapidly detect failures within the virtual chassis. For example, if the Hello time interval is set to 100 milliseconds, the VC topology engine 24 is able to determine that a failure has occurred on a VFL link or on a VC switch if the VC topology engine 24 does not receive a Hello PDU on a link or from a particular VC switch within a predetermined multiple of 100 milliseconds (i.e., after two Hello time intervals have passed without receiving a Hello PDU from a particular switch, the VC topology engine determines that a failure has occurred on that particular switch).

Thus, the VC topology engine 24 can maintain a timer or other tool to monitor the duration of time between successive Hello PDU's received at a particular VFL port 30a-30c and/or from a particular VC switch. The VC topology engine 24 may further include a set of instructions to determine whether a failure has been occurred based on the duration of time that has elapsed between successively received Hello PDUs. In addition, the VC topology engine 24 can maintain a set of instructions that causes the VC topology engine 24 to recover upon the detection of a failure. For example, the set of instructions may instruct the VC topology engine 24 to rebuild the topological map of the virtual chassis and update the SPT 28 based on the new topological map.

In another embodiment, the received VC-ISIS PDUs 300 are customized Link State PDU's. In addition, the switch 20 can also generate customized Link State PDUs and transmit the Hello PDUs out all of the VFL ports 30a-30c. As discussed above, the customized Link State PDU's 300 include topology information 320 that is specific to the virtual chassis. For example, the customized Link State PDUs 300 can include license information, switch priority, switch uptime and an identifier of the master switch within the virtual chassis. It should be understood that the VC-specific topology information 320 included in the customized Hello and/or Link State PDUs can vary, and embodiments are not limited to any particular type of VC topology information. In addition, it should be understood that the VC-specific topology information 320 may be included in only customized Hello PDUs or only customized Link State PDUs (and not both types of PDUs).

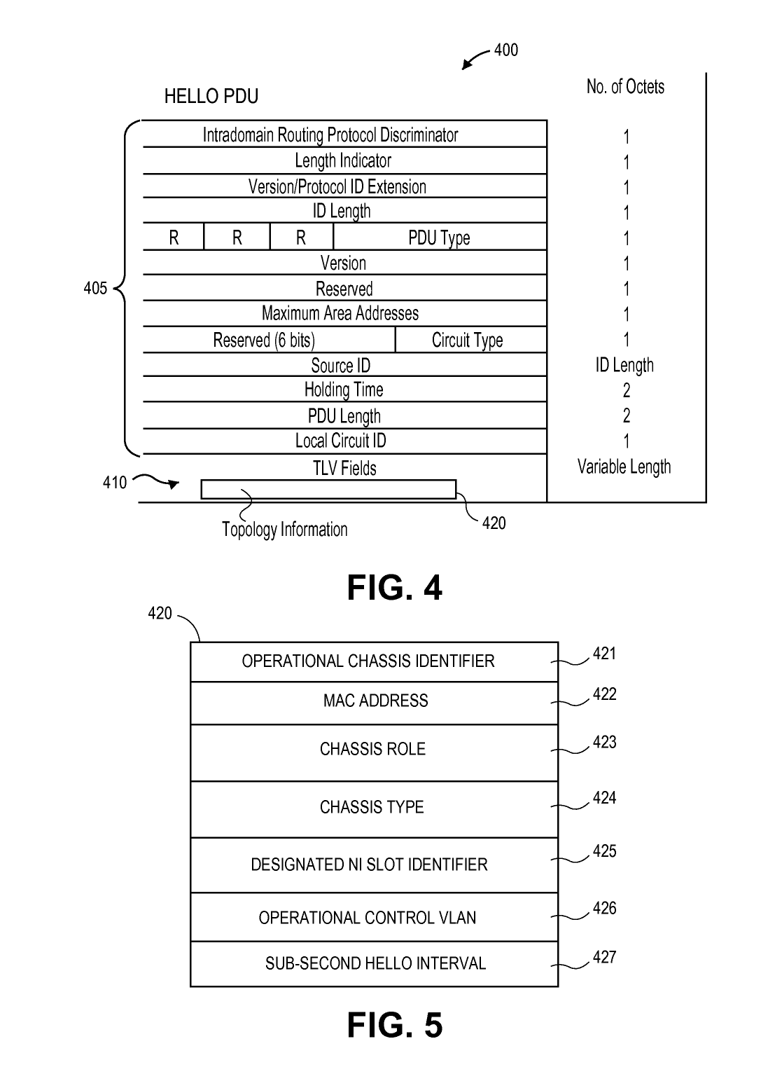

FIG. 4 illustrates an exemplary format for a VC-ISIS (customized) Hello PDU 400. The VC-ISIS Hello PDU 400 includes standard Hello fields 405 (such as Intradomain Routing Protocol Discriminator, Length Indicator, etc.), along with Type/Length/Value (TLV) fields 410. Within the TLV fields 410, various VC-specific topology information 420 can be included. By way of example, but not limitation, as shown in FIG. 5, such topology information 420 can include the Operational Chassis Identifier 421 (i.e., the unique identifier of the switch within the virtual chassis), along with the MAC Address 422 of the switch. In addition, the topology information 420 can include the Chassis Role 423 (i.e., whether the switch is a master or slave), the Chassis Type 424, the Designated Network Interface (NI) Slot Identifier 425 (i.e., the identifier of the NI card(s) that connect to other VC switches), and the Operational Control VLAN 426 (i.e., the particular VLAN's (VLAN tag ID's) that the switch is responsible for). The topology information 420 may also include the Sub-Second Hello interval 427, as discussed above.

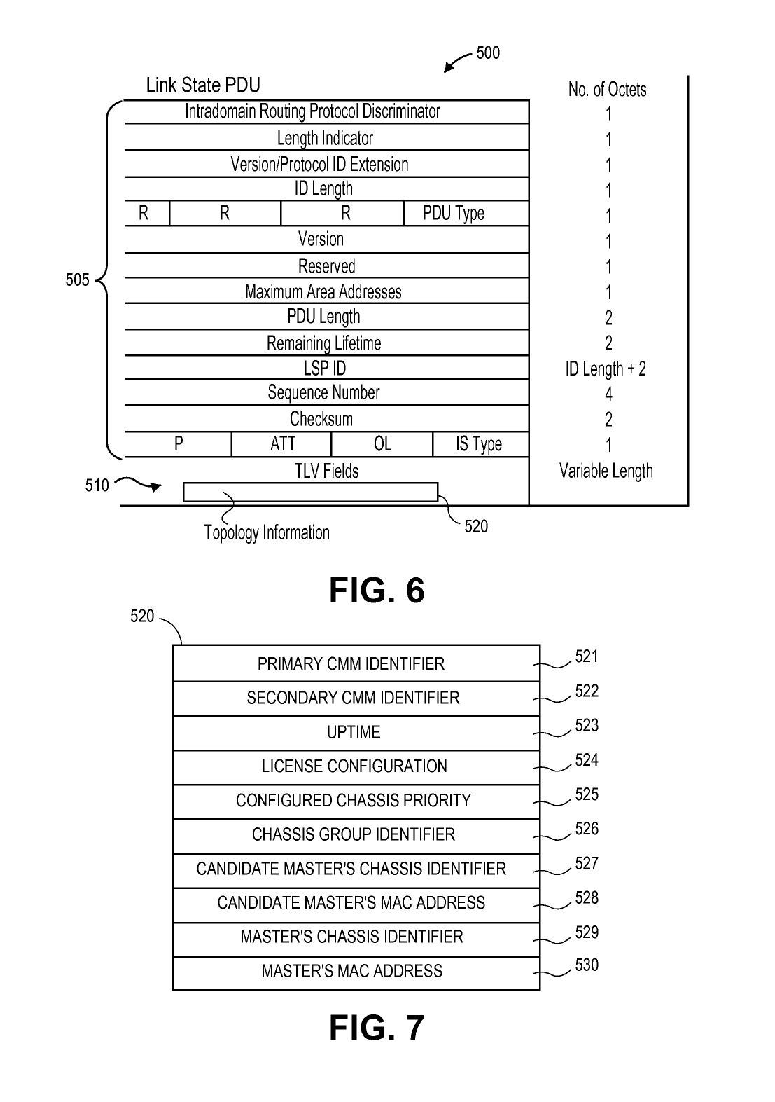

FIG. 6 illustrates an exemplary format for a VC-ISIS (customized) Link State PDU 500. The VC-ISIS Link State PDU 500 includes standard Link State fields 505 (such as Intradomain Routing Protocol Discriminator, Length Indicator, etc.), along with Type/Length/Value (TLV) fields 510. Within the TLV fields 510, various VC-specific topology information 520 can be included. By way of example, but not limitation, as shown in FIG. 7, such topology information 520 can include the Primary CMM Identifier 521 and Secondary CMM Identifier 522, the Uptime (i.e., the duration of time that the switch has been operational), License Configuration 524 (i.e., information related to software licenses for software installed on the switch and/or other switches within the virtual chassis), Configured Chassis Priority 525 (i.e., the priority of the switch within the virtual chassis) and the Chassis Group Identifier 526 (i.e., the virtual chassis identity). In addition, the topology information 520 may also include the Candidate Master's Chassis Identifier 527 (i.e., the unique identifier for the back-up master switch within the virtual chassis), the Candidate Master's MAC Address 528, the Master's Chassis Identifier 529 (i.e., the unique identifier for the master switch within the virtual chassis) and the Master's MAC Address 530.

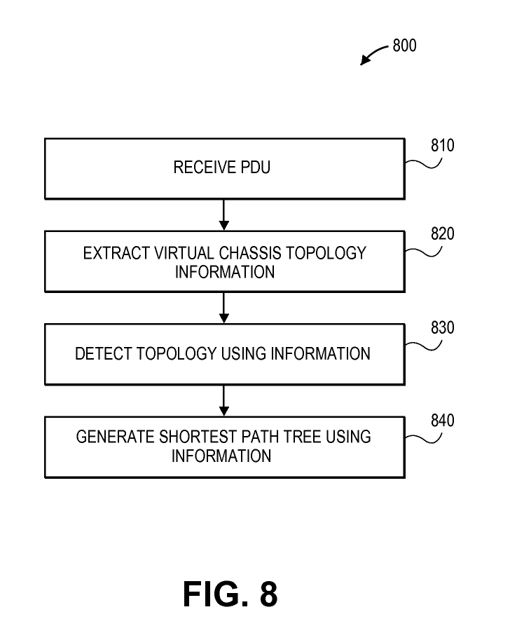

FIG. 8 illustrates an exemplary flow diagram of a method 800 for topology management within a virtual chassis. The method begins at 810, where a VC-ISIS Protocol Data Unit (PDU) is received on a VFL link of a switch within a virtual chassis. At 820, the switch extracts virtual chassis topology information from the VC-ISIS PDU. From the virtual chassis topology information, the switch detects the topology of the virtual chassis, at 830, and generates a shortest path tree, at 840.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may be used herein, the term “operable to” indicates that an item includes one or more of processing modules, data, input(s), output(s), etc., to perform one or more of the described or necessary corresponding functions and may further include inferred coupling to one or more other items to perform the described or necessary corresponding functions. As may also be used herein, the term(s) “connected to” and/or “connecting” or “interconnecting” includes direct connection or link between nodes/devices and/or indirect connection between nodes/devices via an intervening item (e.g., an item includes, but is not limited to, a component, an element, a circuit, a module, a node, device, etc.). As may further be used herein, inferred connections (i.e., where one element is connected to another element by inference) includes direct and indirect connection between two items in the same manner as “connected to”.

Embodiments have also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by one or multiple discrete components, networks, systems, databases or processing modules executing appropriate software and the like or any combination thereof.

What is claimed is:

1. A switch within a virtual chassis including at least two switches, the switch comprising:
a plurality of virtual fabric link (VFL) ports coupled to a VFL, wherein the VFL interconnects each of the at least two switches within the virtual chassis to enable the at least two switches to operate as a single logical switch;
a processor for:
receiving a customized protocol data unit (PDU) from an additional switch within the virtual chassis via one of the VFL ports,
extracting virtual chassis topology information from protocol extensions within the PDU, and
using the virtual chassis topology information to detect a topology of the virtual chassis and generate a shortest path tree for use in routing within the virtual chassis.

2. The switch of claim 1, wherein the customized PDU is one of a customized Hello PDU and a customized Link State PDU and the protocol extensions are type length value fields within the customized PDU.

3. The switch of claim 2, wherein the customized Hello PDU includes a sub-second Hello interval within one of the type length value fields that indicates a sub-second time interval between successive customized Hello PDUs transmitted from the additional switch.

4. The switch of claim 1, wherein the VFL ports are coupled to respective VFL links, each coupling the switch to one of the other at least two switches.

5. The switch of claim 1, wherein the processor further uses the virtual chassis topology information within the customized PDU and additional virtual chassis topology information within additional customized PDUs received from other ones of the switches within the virtual chassis to detect each of the at least two switches within the virtual chassis.

6. The switch of claim 1, wherein the processor further uses the virtual chassis topology information to elect a master switch for the virtual chassis from the at least two switches.

7. The switch of claim 6, wherein the processor elects the master switch using one or more of a switch priority of the additional switch, an uptime of the additional switch, an identifier of the additional switch and a Media Access Control (MAC) address of the additional switch, each included within the virtual chassis topology information.

8. The switch of claim 1, wherein the virtual chassis includes at least six switches coupled to each other in a mesh topology.

9. The switch of claim 1, further comprising:
a memory maintaining forwarding tables; and
wherein the processor programs the shortest path tree into the forwarding tables.

10. The switch of claim 1, wherein the processor further uses the virtual chassis topology information to detect a failure of one or more of the at least two switches within the virtual chassis and to generate a new shortest path tree upon detection of the failure.

11. The switch of claim 1, wherein the virtual chassis topology information includes:
an identifier of the additional switch;
a MAC address of the additional switch;
an indication of whether the additional switch is a master switch or a slave switch;
a type of the additional switch;
a slot identifier identifying a network interface slot of the additional switch to which the switch is coupled;
a Virtual Local Area Network (VLAN) identifier of a VLAN managed by the additional switch; and
a sub-second time interval between successive PDUs transmitted from the additional switch.

12. The switch of claim 1, wherein the virtual chassis topology information includes one or more of:
an identifier of at least one chassis management module within the additional switch;
an uptime of the additional switch;
license information for software configured on the additional switch;
a switch priority of the additional switch;
an identifier of the virtual chassis;
an identifier of a master switch within the virtual chassis; and
an identifier of a candidate master switch within the virtual chassis.

13. A non-transitory memory device having tangibly embodied thereon and accessible therefrom a set of instructions interpretable by at least one processor, the set of instructions configured for causing the processor to carry out operations for:
receiving customized protocol data units (PDUs) from switches within a virtual chassis at a receiving one of the switches via one of a plurality of VFL ports, the plurality of VFL ports being coupled to a VFL, wherein the VFL interconnects each of the switches within the virtual chassis to enable the switches to operate as a single logical switch;
extracting virtual chassis topology information from protocol extensions within the customized PDUs; and
using the virtual chassis topology information to detect a topology of the virtual chassis and generate a shortest path tree for use in routing between the switches within the virtual chassis.

14. The memory of claim 13, wherein:
the customized PDUs include at least one of customized Hello PDUs and customized Link State PDUs and the protocol extensions are type length value fields within the customized PDUs; and
the customized Hello PDUs each include a sub-second Hello interval within one of the type length value fields that indicates a sub-second time interval between successive customized Hello PDUs transmitted by each of the switches within the virtual chassis.

15. The memory of claim 13, wherein the set of instructions further causes the processor to carry out operations for:
using the virtual chassis topology information within the customized PDUs to detect each of the switches within the virtual chassis.

16. The memory of claim 13, wherein the set of instructions further causes the processor to carry out operations for:
using the virtual chassis topology information to elect a master switch for the virtual chassis from the at least two switches.

17. The memory of claim 13, wherein the set of instructions further causes the processor to carry out operations for:
using the virtual chassis topology information to detect a failure of one or more of the at least two switches within the virtual chassis and to generate a new shortest path tree upon detection of the failure.

18. The memory of claim 13, wherein the virtual chassis topology information within a customized PDU received from a transmitting switch within the virtual chassis includes:
an identifier of the transmitting switch;
a MAC address of the transmitting switch;
an indication of whether the transmitting switch is a master switch or a slave switch;
a type of the transmitting switch;
a slot identifier identifying a network interface slot of the transmitting switch to which the switch is coupled;
a Virtual Local Area Network (VLAN) identifier of a VLAN managed by the transmitting switch; and
a sub-second time interval between successive PDUs transmitted from the transmitting switch.

19. The memory of claim 13, wherein the virtual chassis topology information within a customized PDU received from a transmitting switch within the virtual chassis includes:
an identifier of at least one chassis management module within the transmitting switch;
an uptime of the transmitting switch;
license information for software configured on the transmitting switch;
a switch priority of the transmitting switch;
an identifier of the virtual chassis;
an identifier of a master switch within the virtual chassis; and
an identifier of a candidate master switch within the virtual chassis.

20. A method for topology management within a virtual chassis, comprising:
receiving customized protocol data units (PDUs) from switches within the virtual chassis at a receiving one of the switches via one of a plurality of VFL ports, the plurality of VFL ports being coupled to a VFL, wherein the VFL interconnects each of the switches within the virtual chassis to enable the switches to operate as a single logical switch;
extracting virtual chassis topology information from protocol extensions within the customized PDUs; and
using the virtual chassis topology information to detect a topology of the virtual chassis and generate a shortest path tree for use in routing between the switches within the virtual chassis.
